(19) United States
(12) Patent Application Publication
(10) Pub. No.: US 2004/0054945 A1
(43) Pub. Date: Mar. 18, 2004

(54) Symbol support in embedded firmware images

(76) Inventor: Gerald E. Smith, Suwanee, GA (US)

Correspondence Address: LSI LOGIC CORPORATION, 1621 BARBER LANE, MS: D-106 LEGAL, MILPITAS, CA, 95035, US

(21) Appl. No.: 10/245,271

(22) Filed: Sep. 17, 2002

(51) Int. Cl. H04L 1/22

(52) U.S. Cl. 714/38

(57) ABSTRACT

A method for debugging firmware includes downloading a symbol table into the firmware. The symbol table may be downloaded separately from the executable program or may be downloaded as part of a linker output file. Debugging may include address and symbol name lookups, listing all symbols, listing symbols based on a predetermined criterion, and dumping the memory contents for one or more symbol names.

### FIELD OF THE INVENTION

The present invention generally relates to the field of program debugging techniques, and particularly to a method of debugging a program using symbol support in embedded firmware images.

### BACKGROUND OF THE INVENTION

Software code is known to sometimes suffer from unanticipated performance problems. Certain operational conditions may not have been anticipated during the creation of the software code. Also, software code that interfaces with other software code may experience problems in communicating. Firmware loaded with a program may experience problems in which processing locks up, erroneous results are produced, and the like. The existing debugging techniques for firmware lack the ability to dynamically provide symbol support for debugging. That is, a user currently lacks the ability to track changes in value or know the last value of variables according to easily readable symbol names. Instead, the user faces the task of deciphering binary code or sorting through memory dump contents presented according to a numeric memory address. Debugging firmware has typically involved the use of external tools to provide symbol access. The debugging tools are rarely available at the customer location.

Therefore, it would be desirable and more convenient to facilitate debugging of firmware at the locus in quo of the firmware.

### SUMMARY OF THE INVENTION

Accordingly, the present invention is directed to a method and system for debugging firmware at the firmware locus. This may be accomplished by utilizing a symbol table at the firmware locus.

The present invention relates to a method for symbol support in an embedded firmware image includes the steps of storing an executable program in firmware; storing a symbol table associated with the executable program in firmware; and, upon the occurrence of an error, debugging the executable program of the firmware using a symbol table.

The present invention relates to a method of providing a symbol table to firmware that includes the steps of extracting the symbol table from a linker output file, converting the symbol table to a format easily used by the firmware at run-time, and including the formatted symbol table in an executable firmware binary image.

The present invention relates to a system for debugging firmware that includes firmware including an executable program and a symbol table and a display coupled to the firmware for displaying symbol related information during a debugging procedure.

The present invention assists with debugging firmware and system problems by displaying data using symbol names, resulting in faster problem identification and resolution.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates the flowchart of an embodiment of the method of the present invention;

FIG. 2 illustrates an embodiment of the method of the present invention in which the symbol table is extracted from a linker output file and appended to the end of the program stored in firmware;

FIG. 3 illustrates an embodiment of the method of the present invention in which the entire linker file with symbol table is loaded into firmware;

FIG. 4 illustrates an exemplary format for an entry in the symbol table of the present invention;

FIG. 5 illustrates an exemplary format for the symbol table of the present invention;

FIGS. 6A and 6B illustrate substeps in debugging step 50 of FIG. 2 using the symbol table in an exemplary embodiment of the method of the present invention; and

FIG. 7 illustrates an exemplary functional block diagram of the present invention.

### DETAILED DESCRIPTION OF THE INVENTION

Reference will now be made in detail to the presently preferred embodiments of the invention, examples of which are illustrated in the accompanying drawings.

The present invention relates to a method to facilitate debugging of a program stored in firmware using a symbol table. Firmware refers to software that resides in non-volatile read only memory, such as ROM, PROM, EPROM, and EEPROM. The symbol table may be extracted from a linker output file that is appended to the program before or after loading the firmware. Alternatively, an entire linker output file with a symbol table may be loaded into the firmware. Various presentation formats of symbol related data may be made available to the user. It is understood that a symbol may be an eight-bit byte string representing an ASCII (American Standard Code for Information Interchange), EBCDIC (Extended Binary Coded Decimal Interchange Code), or other data code character.

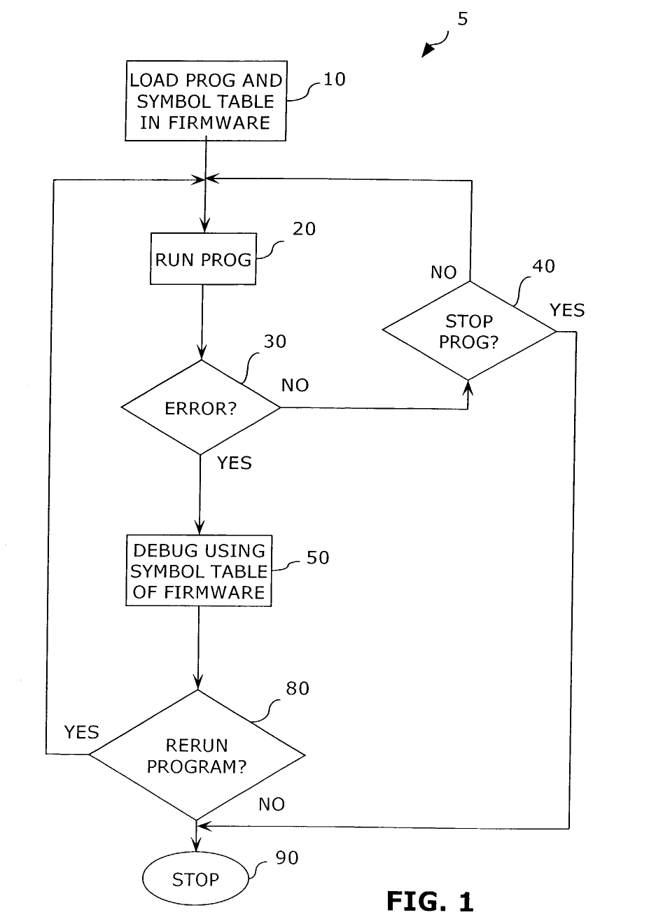

FIG. 1 illustrates the method 5 of the present invention. In step 10, the executable program and the symbol table corresponding to this program are loaded into firmware. As the program runs 20, a determination is made if an error has occurred 30. Identification of an error may be the result of a prohibited pattern of bits, an interrupt signal, a time out, a value which is out of bounds, and the like. Unless an error is detected, the program periodically checks for the presence of a stop command 40. The stop command may be a flag bit loaded into a status register, a buffered user input, or the like. The user input may come through a graphical user interface input, a manually activated button, and the like. Barring receipt of a stop command, normal mode processing continues 20. If an error is determined to have occurred 50, the system enters a debug mode. A graphical user interface may be used to view a data dump including symbol name, symbol address, value of the symbol, and the like. After debugging, if a user chooses to rerun the program 80, processing continues 20; otherwise, program execution stops 90.

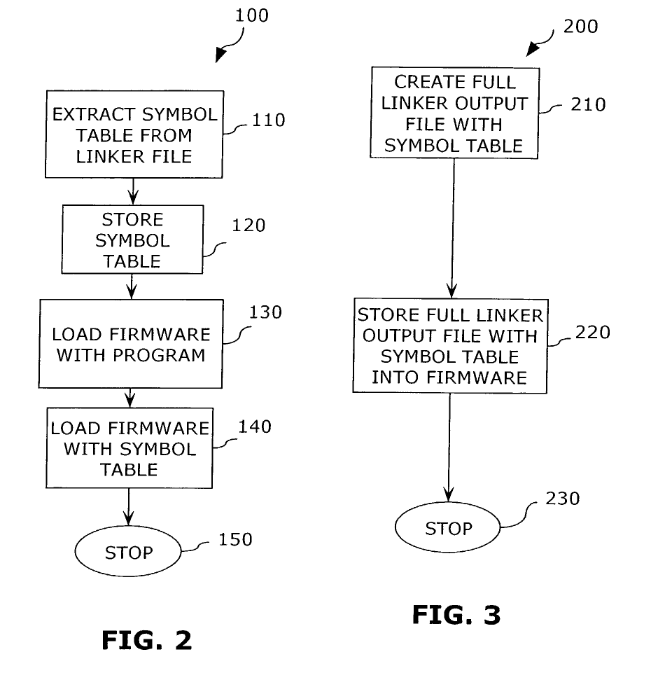

FIG. 2 illustrates a first embodiment of the method of loading the symbol table in the firmware of the present invention. Various techniques may be used to extract the symbol table from a linker output file 110. For example, the symbol table may be extracted by software code which recognizes the start and end locations of the symbol table. Individual symbol names and associated data may be extracted by parsing through the extracted symbol table. The software code may create associations between addresses in the linker output file and the symbols. These associations identify each symbol by one address. Each address is one or more bytes long. Further processing by the software code may assign various information regarding the symbol, such as a null termination character. The symbol and information associated with the symbol is stored 120 in memory for later processing. The firmware is loaded with an executable program 130. Afterward, the program may load the symbol table in the firmware 140, then stop processing 150. Various techniques may be employed to extract to symbol table from the linker output file and convert the symbol table to a format used by the run time firmware. An example is provided immediately below in pseudo code.

Program EXTRACT

Identify start of symbol table
Loop to parse through body of symbol table

Find start of symbol
Retrieve symbol name and associated information
If symbol is not the null character, return to loop

End Program EXTRACT
Program CROSS REFERENCE

N = 1
Loop

Retrieve symbol name N
Find symbol name N as represented in executable firmware
binary image
Cross reference symbol name to corresponding locations
in the executable firmware binary image
Increment N
If symbol name N is not equal to the NULL character,
return to loop

End Program CROSS REFERENCE

A specific implementation of a software routine for extracting the symbol table is provided below.

```
/*
****************************************************************
*****
*
*
* This program generates a .SYM file from an ELF file.
* A .SYM file contains a binary copy of the symbol table.
* The format is “symbol string”, NULL, 4-byte address (LE). The string is
* null-terminated and not quoted. The list is terminated by a null.
*
****************************************************************
*****
*/
#include <stdio.h>
#include <stdlib.h>
#include <fcntl.h>
#include <io.h>
#include <string.h>
#include “elf/common.h”
#include “elf/external.h”
/*
  * declare internal macros
  */
/*
  * declare internal typedefs
  */
typedefunsigned char uchar;
typedefunsigned int uint;
typedefunsigned long ulong;
typedefunsigned short ushort;
/*
  * declare internal function prototypes
  */
static void dofile(FILE *ifp, char *fname);
static void dosect(FILE *infile, uint size);
static void send(char *p, int n);
static void doSyms(FILE *fp, Elf32_External_Ehdr *ehdr);
char *usage[] = {
```

“usage: ElfToSym file”,
“\tgenerate binary symbol records for appending to a firmware image.”,
“\tThe output (binary) is send to stdout.”,
0};

```
int  filecount = 0;
/*
  ****************************************************************
  *****
  *
  * Main function
  *
  * Process the command line arguments and then convert each file
  */
main(int argc, char *argv[])
{
```

FILE *fp;
int i,j;
for (i=1;i<argc;i++) { /* first find all the options */

if (argv[i] [0] == ‘−’) { /* must be an option */

fprintf(stderr,“%s: bad option\n”,argv[i]);
for (j=0;usage[j];j++)

fprintf(stderr,“%s\n”,usage[j]);

exit(−1);

} else /* must be a file */

filecount++;

}
_setmode(_fileno(stdout),_O_BINARY);
if (filecount == 0)

dofile(stdin, “stdin”);

else {

for (i=1;i<argc;i++) { /* do the files */

if (argv[i][0] != ‘−’) { /* must be a filename */

```
fp = fopen(argv[i],“r”);
if (! fp) {
    fprintf(stderr,“can't open %s\n”,argv[i]);
    exit(−1);
}
dofile(fp, argv[i]);
fclose(fp);
```

}

}

}
return 0;

```
}
/*
  *----------------------------------------------------------------
  *
  * dofile(ifp, fname)
  *
  * Process the given input file.
  */
static  void  dofile(FILE *ifp, char *fname)
{
```

```
Elf32_External_Ehdr ehdr;
Elf32_External_Phdr phdr;
uint ph;
/*
  * read the header and make sure we support it
  */
_setmode(_fileno(ifp),_O_BINARY);
fread(&ehdr, sizeof(ehdr), 1, ifp); /* read the ELF header */
if(ehdr.e_ident[EI_MAG0] != ELFMAG0 ∥ ehdr.e_ident[EI_MAG1] !=
```

ELFMAG1 ∥

ehdr.e_ident[EI_MAG2] != ELFMAG2 ∥ ehdr.e_ident[EI_MAG3] !=

ELFMAG3) {

fprintf(stderr, “ElfToSym: Input file is not ELF format\n”);
exit(1);

}
if (ehdr.e_ident[EI_CLASS] != ELFCLASS32) {

fprintf(stderr, “ElfToSym: ELF input file must be 32-bit\n”);
exit(1);

}
if (ehdr.e_ident[EI_DATA] != ELFDATA2LSB) {

fprintf(stderr, “ElfToSym: ELF input file must be Little-Endian\n”);
exit(1);

}
if (ehdr.e_type != ET_EXEC) {

fprintf(stderr, “ElfToSym: ELF input file must be exectuable type\n”);
exit(1);

```
}
/*
  * process the symbols
  */
doSyms(ifp, &ehdr);
```

```
}
/*
  *----------------------------------------------------------------
  *
  * doSyms function
  *
  * Write the symbols to the output file.
  */
static void  doSyms(FILE *fp, Elf32_External_Ehdr *ehdr)
{
```

```
Elf32_External_Shdr *shdr, *sh;
Elf32_External_Shdr *shStr=NULL, *shSym=NULL;
uint  shSize = ehdr->e_shentsize * ehdr->e_shnum;
char  *shStrTab;
Elf32_External_Sym *symTab, *st;
char  *strTab;
uint  i;
char  *p;
uint  len;
/*
  * allocate a buffer and read the section headers
*/
shdr = (Elf32_External_Shdr *)malloc(shSize);
fseek(fp, ehdr->e_shoff, 0);
fread(shdr, shSize, 1, fp);
/*
  * read the section header string table
  */
shStrTab = (char *)malloc(shdr[ehdr->e_shstrndx].sh_size);
fseek(fp, shdr[ehdr->e_shstrndx].sh_offset, 0);  /* seek to section hdr
```

location */

```
fread(shStrTab, shdr[ehdr->e_shstrndx].sh_size, 1, fp); /* read the string table
*/
  /*
  * find the string and symbol secitons in the section header table
*/
for (sh=shdr; sh<shdr+ehdr->e_shnum; sh++) {
```

if (sh->sh_size == 0)

continue;

if (strcmp(“.symtab”, shStrTab+sh->sh_name) == 0)

shSym = sh;

else if (strcmp(“.strtab”, shStrTab+sh->sh_name) == 0)

shStr = sh;

}
if(shStr == NULL ∥ shSym == NULL) {

fprintf(stderr, “ElfToFat: Symbol table missing”);
return;

```
}
/*
  * read the string table into memory
  */
strTab = (char *)malloc(shStr->sh_size);
fseek(fp, shStr->sh_offset, 0);
fread(strTab, shStr->sh_size, 1, fp);
/*
  * read the symbol table into memory
  */
symTab = (Elf32_External_Sym *)malloc(shSym->sh_size);
fseek(fp, shSym->sh_offset, 0);
fread(symTab, shSym->sh_size, 1, fp);
/*
  * scan the symbol table and add all function and data symbols to the file
*/
for (i=0; i<shSym->sh_size/sizeof(symTab[0]); i++) {
    int skipIt = 1;
    st = &symTab[i];
    if (ELF_ST_BIND(st->st_info) == STB_LOCAL &&
    (ELF_ST_TYPE(st->st_info) == STT_FUNC ∥
    ELF_ST_TYPE(st->st_info) == STT_NOTYPE)) /* GES 5/23/02 —
```

added to get Xscale static symbols */

skipIt = 0; /* process static functions and variables */

```
    if (ELF_ST_BIND(st->st_info) == STB_GLOBAL &&
    (ELF_ST_TYPE(st->st_info) != STT_OBJECT ∥
    ELF_ST_TYPE(st->st_info) != STT_FUNC))
```

skipIt = 0; /* process global functions and variables */

if (skipIt)

continue;

p = strTab+st->st_name; /* get symbol pointer */
if (*p == 0) /* skip NULL symbols */

continue;

if(strchr(p, ‘. ’))

continue; /* skip symbols with period —usually

local structure entries */

len = strlen(p);
fwrite(p, sizeof(p[0]), len+1, stdout); /* output the name /*
fwrite(&st->st_value, sizeof(st->st_value), 1, stdout); /* output the

address*/

}
putc(0, stdout); /* output the symbol table terminator */

}

FIG. 3 illustrates a second embodiment 200 of the method of loading the symbol table in the firmware of the present invention. A full linker output file with symbol table is generated 210 and may be temporarily stored in a memory. The full linker output file with symbol table is loaded into firmware 220, then processing stops 230.

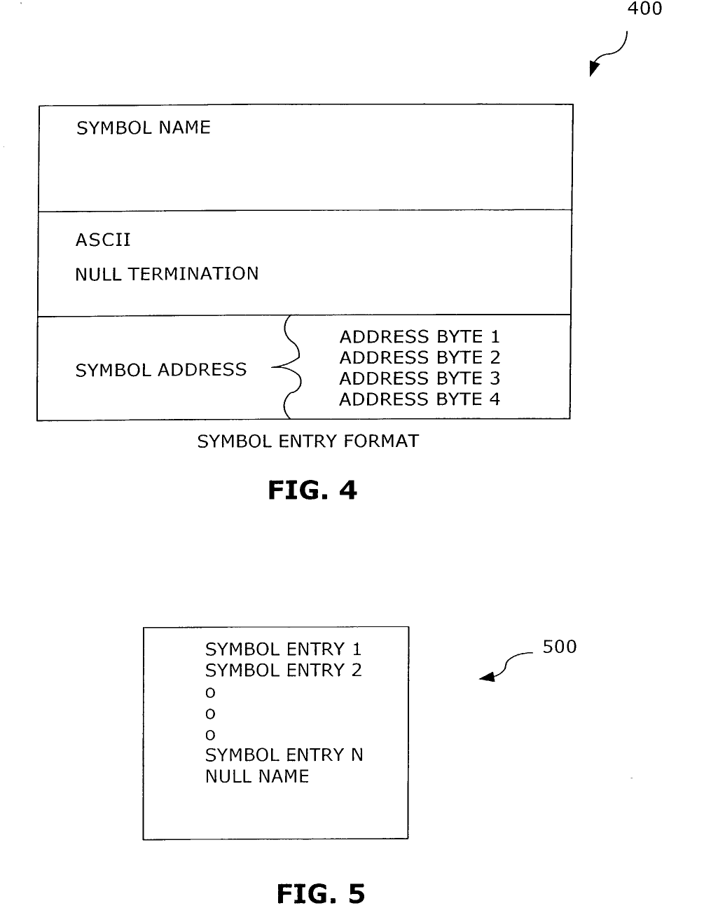

FIG. 4 illustrates an exemplary format of an entry 400 in a symbol table that is loaded into the firmware. The symbol name may be an ASCII character of one or more bytes. The symbol name is terminated by a null character. The entry includes a symbol address. The symbol address includes one or more bytes. For example, FIG. 4 shows a four byte symbol address.

FIG. 5 illustrates the format 500 of the symbol table. Successive symbol entries are appended within the symbol table. The list of symbol entries may be terminated by a null name or other suitable termination character.

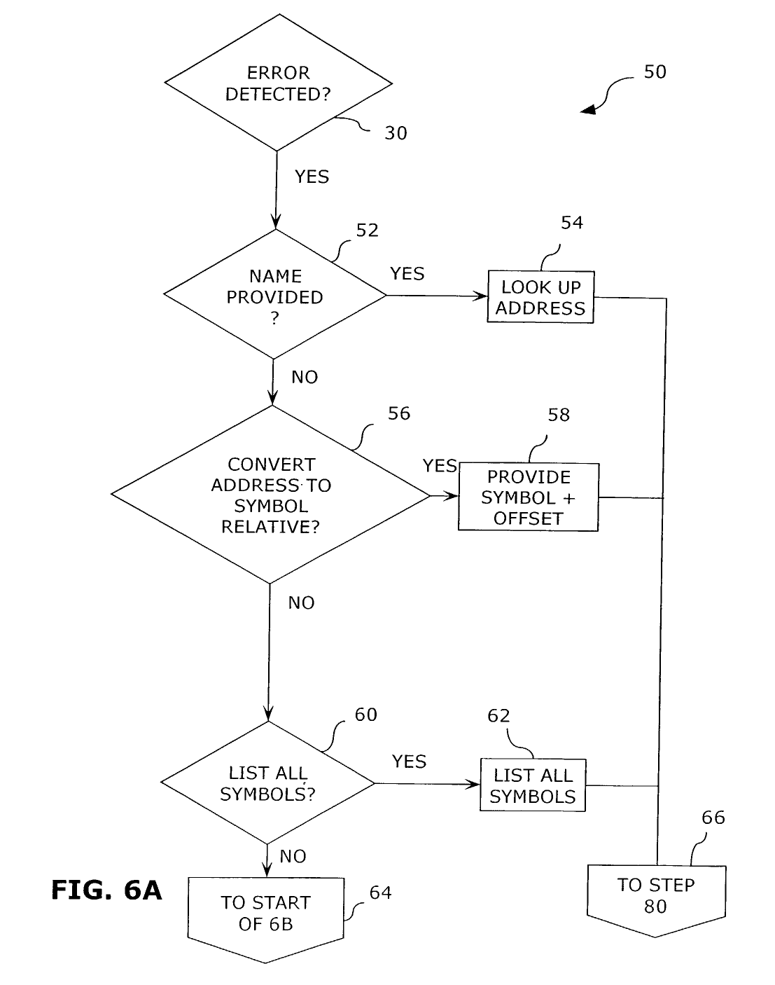

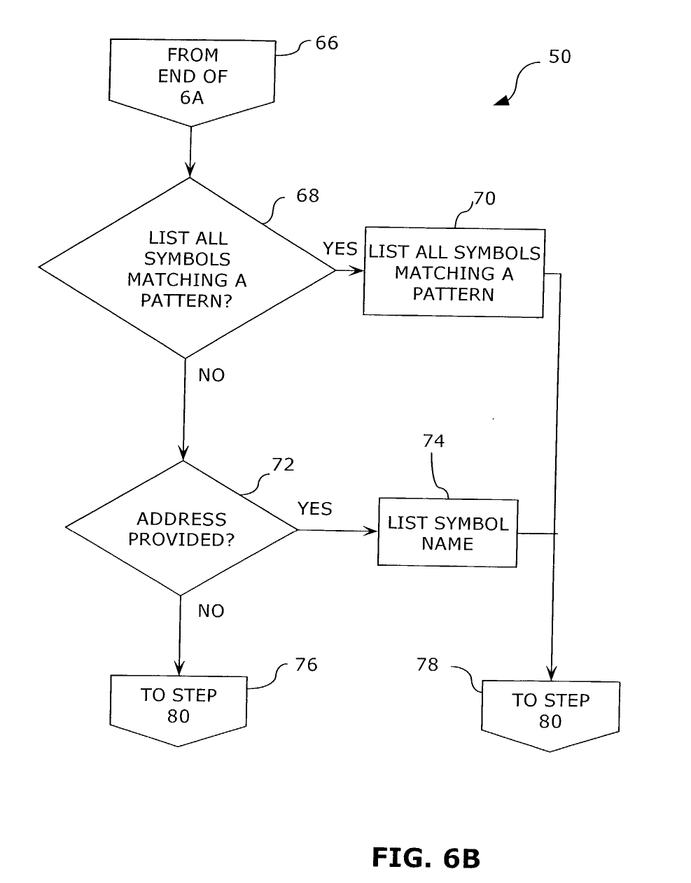

FIGS. 6A and 6B illustrate exemplary substeps in debugging step 50. If an error is detected 50, a determination is made as to whether a symbol name has been provided 52 through user input. If the user has input a symbol name, then addresses corresponding to the symbol name are looked up 54 in the memory containing the executable program. Data containing in memory locations corresponding to those addresses may be stored or displayed. Then, the user decides whether to end the debug operation 80. If no symbol has been provided, the program then checks for a command to convert an address to a symbol associated address 56. This command may be supplied by manual input or may be generated by an algorithm. If there is an address to convert, then a symbol name and offset address is provided 58. At the option of the user or as determined by an algorithm, debug processing may end 80. If there is no request or command to convert the address to a symbol associated address, a decision is made to list all symbols 60. If all symbols are to be listed, then all symbols are listed 62 and debugging processing may be terminated 80. Otherwise, a determination is made as to whether to list all symbols matching a certain pattern 68. If any symbols match a certain pattern, those symbols are listed 70 and debug processing may be ended 80. If no symbols match a pattern, then a determination is made as to whether an address has been provided 72. If an address has been provided, the symbol name corresponding to this address is listed 74. Debug processing may then be terminated 80. The debugging requests may be made through a graphical user interface. The response to the request may include a full dump of associated memory contents. The results may be displayed on a monitor or printed out. Variations of the processing include choosing multiple options simultaneously or multiple loops to repeat options.

Various search mechanisms may be employed for scanning through the symbol table. For example, the following code may be used for searching a desired string in the symbol table at run-time by starting at the address of the first symbol, and scanning sequentially, searching for the desired string.

For (s=SymStart; sl=strlen(s); s+=sl+5)

If (strequ(s, name))

Goto FOUND;

NOT_FOUND;

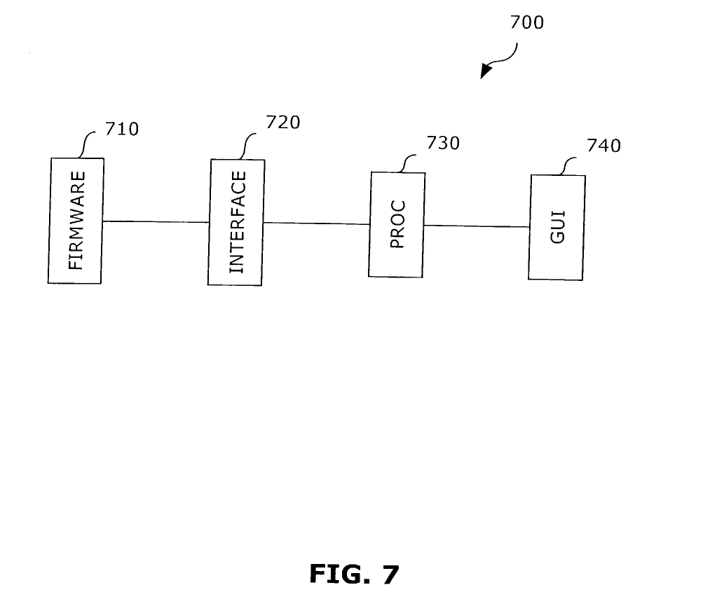

FIG. 7 illustrates a functional block diagram of a system 700 of the present invention. A graphical user interface 740 on a monitor coupled to a computer may be used to select the program for downloading to the firmware 710. A processor 730 transmits the program to an interface 720. From the interface 720, the firmware 710 is downloaded.

The firmware debugging process is facilitated by use of the symbol table. The symbol table may be loaded into firmware after the executable file has been loaded or may be loaded as part of a linker output file. Preferably, a user controls the operations to be performed in the debugging process.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for symbol support in an embedded firmware image, comprising the steps of:
storing an executable program in firmware;
storing a symbol table associated with the executable program in firmware;
upon the occurrence of an error, debugging the executable program of the firmware using the symbol table.

2. The method of claim 1, wherein the symbol table is extracted from an linker output file.

3. The method of claim 1, wherein both the executable program and the symbol table are part of a linker output file.

4. The method of claim 1, wherein the step of debugging includes providing an address in response to a symbol name.

5. The method of claim 1, wherein the step of debugging includes providing a symbol name in response to an address.

6. The method of claim 1, wherein the step of debugging includes converting an address to a symbol relative name.

7. The method of claim 6, wherein the symbol relative name includes a symbol name and an offset address.

8. The method of claim 1, wherein the step of debugging includes listing all symbols in the symbol table.

9. The method of claim 1, wherein the step of debugging includes listing only those symbols in the symbol table that satisfy a predetermined criterion.

10. The method of claim 9, wherein the predetermined criterion involves matching a pattern.

11. The method of claim 1, wherein the error is a run time error.

12. A method of providing a symbol table to firmware, comprising the steps of:
extracting the symbol table from a linker output file;
converting the symbol table to a format useable by the firmware at run-time; and
including the formatted symbol table in an executable firmware binary image.

13. The method of claim 12, wherein the step of including the formatted symbol table involves appending the formatted symbol table at an end of the executable firmware binary image.

14. The method of claim 12, wherein the format of the symbol table includes a symbol name and a symbol address.

15. The method of claim 14, wherein the symbol address includes four bytes.

16. The method of claim 14, wherein the symbol name includes an ASCII string terminated by a null character.

17. A system for debugging firmware, comprising:
firmware including an executable program and a symbol table; and
a display coupled to the firmware for displaying symbol related information during a debugging procedure.

18. The system of claim 17, wherein the symbol table is extracted from a linker output file.

19. The system of claim 18, wherein the symbol table is appended to the executable program.

20. The system of claim 17, further comprising a processor for loading the firmware with the symbol table.

21. A system for debugging firmware using a symbol table, comprising:
means for extracting the symbol table from a linker output file;
means for converting the symbol table to a format easily used by the firmware at run-time; and
means for including the formatted symbol table in an executable firmware binary image.

22. The system of claim 21, further comprising means for displaying symbol information during a debugging procedure.

23. The system of claim 22, wherein information about only a portion of symbols from the symbol table is displayed.

24. The system of claim 22, wherein information about all symbols from the symbol table is displayed.
